(19) United States
(12) Patent Application Publication
(10) Pub. No.: US 2011/0255284 A1
(43) Pub. Date: Oct. 20, 2011

(54) LED LIGHT

(75) Inventors: Raymond J. Hiller, Newnan, GA (US); Brett A. Mitchell, Newnan, GA (US)

(73) Assignee: KASON INDUSTRIES, INC., Shenandoah, GA (US)

(21) Appl. No.: 12/784,132

(22) Filed: May 20, 2010

Related U.S. Application Data
(63) Continuation-in-part of application No. 12/759,744, filed on Apr. 14, 2010.

(51) Int. Cl. F21S 4/00

(52) U.S. Cl. 362/249.02

(57) ABSTRACT

A light (10) for replacing a fluorescent bulb includes a base (33) with a two pin contact (35) which is configured to match that of a CFL bulb. The light also includes internal electronic ballast and surge protector circuitry (36). The circuitry is electrically coupled to a plurality of LED lights (37). The LED lights are mounted to a tubular mounting housing (38) and an end plate (40).

### REFERENCE TO RELATED APPLICATION

This is a continuation in part of U.S. patent application Ser. No. 12/759,744 filed Apr. 14, 2010.

### TECHNICAL FIELD

This invention relates to a light, and more specifically to a LED light to replace a fluorescent bulb.

### BACKGROUND OF THE INVENTION

Light fixtures with light bulbs mounted thereto have existed for many years. Oftentimes, light fixtures are utilized in cold environments such as walk in refrigerators and freezers to provide light. However, today's governmental regulations requires that lighting used in commercial refrigeration meets stringent lumen per watt efficiency standards. The standards virtually eliminate previously used incandescent light bulbs under normal conditions because the are inefficient generators of light and they create a large amount of heat in the refrigerated space.

As such, refrigerated spaces are now provided with enclosed and gasket water proof incandescent fixtures with a translucent cover, oftentimes referred to as “jelly jar” covers. A compact florescent bulb (CFL) is currently utilized with these fixtures. However, these CFL bulbs suffer from problems relating to their placement within cold environments such as refrigerated spaces. For example, these refrigerated CFL bulbs take several minutes to warm up enough to produce light. Also, a refrigerated CFL bulb is very inefficient and at −20 degrees Fahrenheit may make less than 10% output when energized. Another problem associated with CFL bulbs in refrigerated spaces stems from the fact that the light fixtures are typically positioned over the door leading into the refrigerated space. This positioning of the light fixtures means that the bulb must project light outwardly from its end to illuminate the far end of the refrigerated space. A CFL bulb however does not project light very well in this direction due to the configuration of the CFL bulb and therefor the far end of the refrigerated space distal the door may not be properly illuminated. Lastly, CFL bulbs include mercury which may be harmful to the environment when improperly disposed.

Accordingly, it is seen that a need remains for a light fixture which may be placed in a refrigerated space and which does not utilize an incandescent bulb. It is to the provision of such therefore that the present invention is primarily directed.

### SUMMARY OF THE INVENTION

In a preferred form of the invention a light for replacing a conventional fluorescent light bulb which comprises a mounting housing having a tubular side wall and an end wall coupled to the tubular side wall, a plurality of LED lights coupled to the mounting housing side wall, a plurality of LED lights coupled to the mounting housing end wall, and a fluorescent light fixture receptacle connector coupled to the mounting housing opposite the end wall and electrically coupled to the LED lights.

### BRIEF DESCRIPTION OF THE DRAWING

FIG. 1 is a perspective view of a combination light and light fixture, shown in partial cross-section, embodying principles of the invention in a preferred form.

FIG. 2 is a rear view of the combination light and light fixture of FIG. 1.

FIG. 3 is a cross-sectional view of a portion of the combination light and light fixture of FIG. 1.

FIG. 4 is a perspective view of the light of FIG. 1.

FIG. 5 is an exploded view of the light of FIG. 1.

FIG. 6 is a perspective view of a light in another preferred form of the invention.

### DETAILED DESCRIPTION

With reference next to the drawings, there is shown a combination light 10 and light fixture 11 in a preferred form of the invention. The light fixture 11 has a base, junction box or main housing 12 and a transparent or translucent optical cover 13 threadably coupled to the main housing 12 so as to provide a watertight enclosure or interior space 14.

The main housing 12 has a pair of mounting flanges 17 having mounting holes 18 therethrough. A mounting bolt or screw may be passed through the mounting hole 18 and into the underlying structure to mount the fixture 11 to the underlying structure, such as the refrigerator interior wall. The housing 12 has a front face 20 with an annular receiver 21 and a rear face 22 with an aperture 23 through which electrical wiring 24 extends that is coupled to a local power source. The main housing 12 may be made of a plastic material.

The optical cover 13 is generally bullet-shaped with a generally cylindrical side wall(s) 26 having an open end 27 and a semi-hemispherical dome closed end 28 defining the interior space 14. The open end 27 of the side wall 26 is configured to mate threadably with the receiver 21 of the main housing 12. The side wall 26 has an longitudinal series of outwardly extending, annular, circumferential prismatic rings or ridges 31. The optical cover 13 may be made of a polycarbonate material or other material which provides adequate strength, light transmission qualities, and adaptability to temperature extremes.

The light 10 is positioned within the interior space 14 of the light fixture 11 and optical cover 13. The light 10 has a base 33 to which an internal housing 34 is mounted. The light base 33 includes a fluorescent light fixture receptacle connector or two pin contact 35 which is configured to match that of a GU-24 CFL bulb, thereby making them interchangeable. The light 10 also includes internal electronic ballast and surge protector circuitry 36 mounted within internal housing 34. The circuitry 36 is electrically coupled to a plurality of LED lights 37.

The LED lights 37 are mounted to a tubular mounting housing 38 having a side wall formed from six elongated side plates or panels 39 and an end plate, wall or panel 40. Each side panel 39 has a matrix of thirty six LED lights 37 which form a tube of LED lights, while the end panel 40 has a matrix of thirty six LED lights 37. The LED lights are positioned in a longitudinally aligned series of annular arrays of LED lights, i.e., in a multitude of annular arrays aligned axially along the longitudinal axis of the light housing. This arrangement of the LED lights may also be considered one elongated annular array of LED lights. The number and arrangement of LED lights may vary according to the amount of produced light and distribution of produced light that is desired. The arrangement of the LED lights produce light which emanates from light 10 in generally a 360 degree pattern about the housing.

A hexagonal shaped external, protective housing 43 having six side cover plates 44 overlays the six LED light side panels 39. The protective housing 43 also includes an annular rear protective ridge 45 and an annular middle protective ridge 46 which are both raised above the exterior surface of the cover plates 44. The term annular, as used herein, is intended to include any loop structure regardless of the exact shape and is not intended to be limited to circular structures. Each cover plate 44 has a matrix of light holes 47 which align with the underlying LED lights 37. Similarly, protective housing 43 has an end wall or plate 48 having light holes 49 therethrough which align with the underlying LED lights 37 of the end panel 40. The end plate 48 is configured to have a size or diameter larger than that of the combined six plates and approximately the same dimensions as the rear and middle ridges 45 and 46 so that it forms a front protective ridge 51 which is elevated with respect to the adjacent, underlying side plates 48. The raised ridges 45, 46 and 51 restrict objects from unwanted or undesired contacting the fragile LED lights, such as when the light 10 is placed upon a table or other such purposeful or accidental contact.

The end plate 48 also includes six corner protective elements or projections 53 and a single middle protective element or projection 54 which extend outwardly to protect the LED lights 37 from accidentally contacting an object and thereby damaging them.

The configuration of the light 10 is designed to allow it to be interchanged with a CFL bulb of a similar size, i.e., the configuration of the two pin contacts 35 and circuitry 36 allow for the present LED based light 10 to replace a CFL light within a standard CFL GU-24 socket.

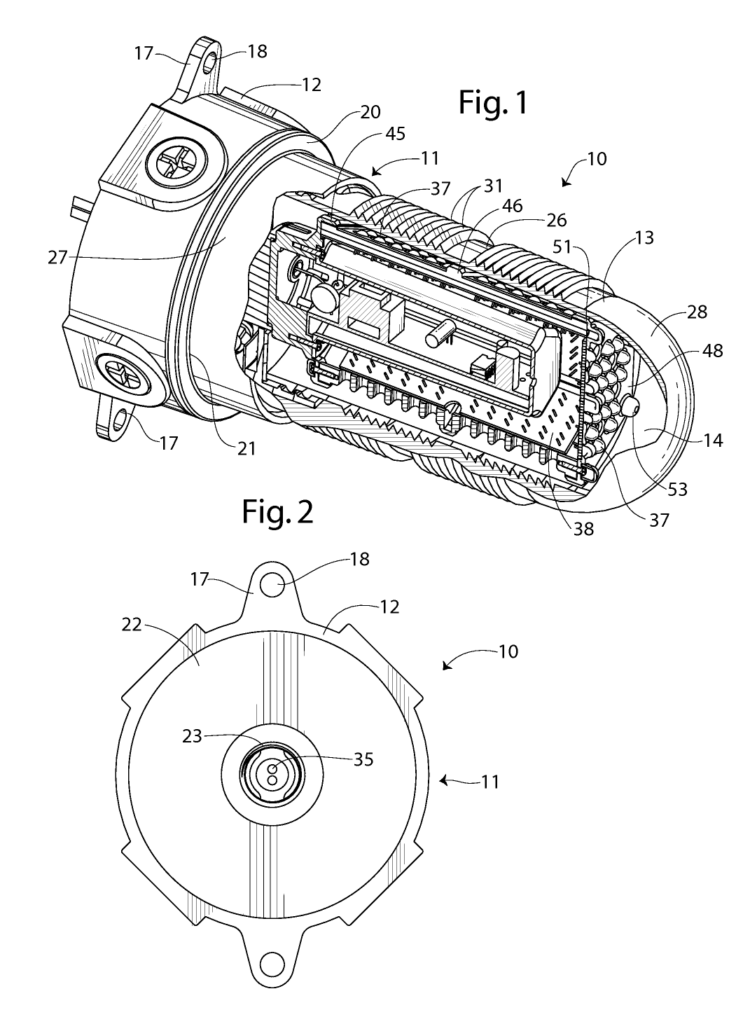

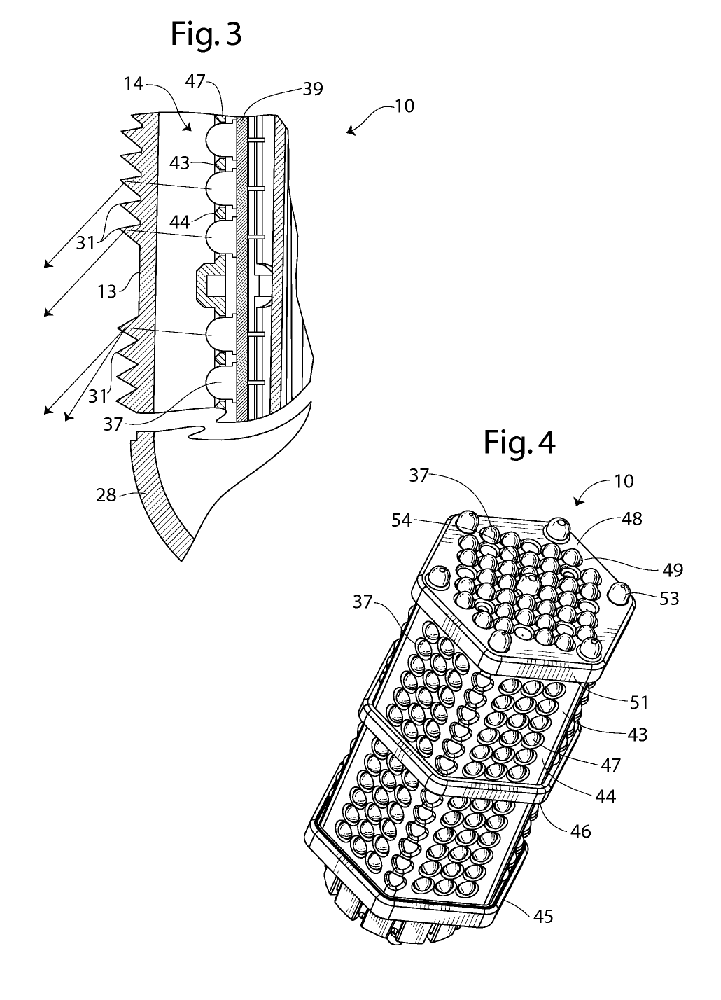

In use and as best shown in FIGS. 1 and 3, the combination light fixture 11 and light 10 typically is mounted to the interior wall of a refrigerated space above the door. The fixture 11 is mounted to the wall by passing mounting screws through flange mounting holes 18 and into the underlying wall. The fixture 11 is coupled to a direct source of electricity through conventional wiring.

The LED lights 37 of the side panels 39 are positioned directly beneath or concentrically within the annular prismatic rings 31 of the optical cover 13. The beveling of the prismatic rings 31 causes axial light emanating from the LED lights to be internally reflected or refracted off the rings 31 in a forward direction away from the main housing and more towards the closed end 28, as indicated by the arrows in FIG. 3. This forward internal reflection or refraction of the light aids in distributing the light forwardly into the room, a great aid when the light fixture is placed in a typical position horizontally (as shown in FIG. 1) above the door. The forwardly projected light illuminates the far side of the room. The LED lights 37 of the end panel 40 also project light forwardly with respect to the typical orientation of a light mounted horizontally above a door.

It has been found that the combination light and light fixture of the present invention provides uniform lighting within a typical food service sized refrigerated storage room. The use of the LED lights also provides instant illumination as there is no warm up period associated with such, as oppose to CFL lights which may take several minutes to fully illuminate in such cold environments.

It should be understood that the light 10 of the present invention may be made of any small number of panels or facets. Also, the packing density of the LED lights is intended to approximate the light output of an incandescent bulb for the intended enclosure.

It should also be understood that as used herein the words transparent and translucent may be used interchangeably is in intended to each include each other.

As such, the optical cover may be described as transparent even though some portions may obscure or hamper the transmission of light and it may also be described as transparent even though it may be made of a clear material which is not intended to diffuse light.

Lastly, it should be understood that the circumferential prismatic ridge or ridges 31 are not required to be continuous and may be in the form of one or more segments. Also, the “concentric” positioning of the LEDs relative to the prismatic ridges is not meant to be strictly construed to mean only those objects with the exact same center point as it is meant to mean a general orientation of two objects wherein one is place within the other. This definition is meant to include different shaped objects, such as the hexagonal shaped light within a the circular cross-section of the optical cover, and positioning wherein the centers are generally in the same area but may not be exactly in common.

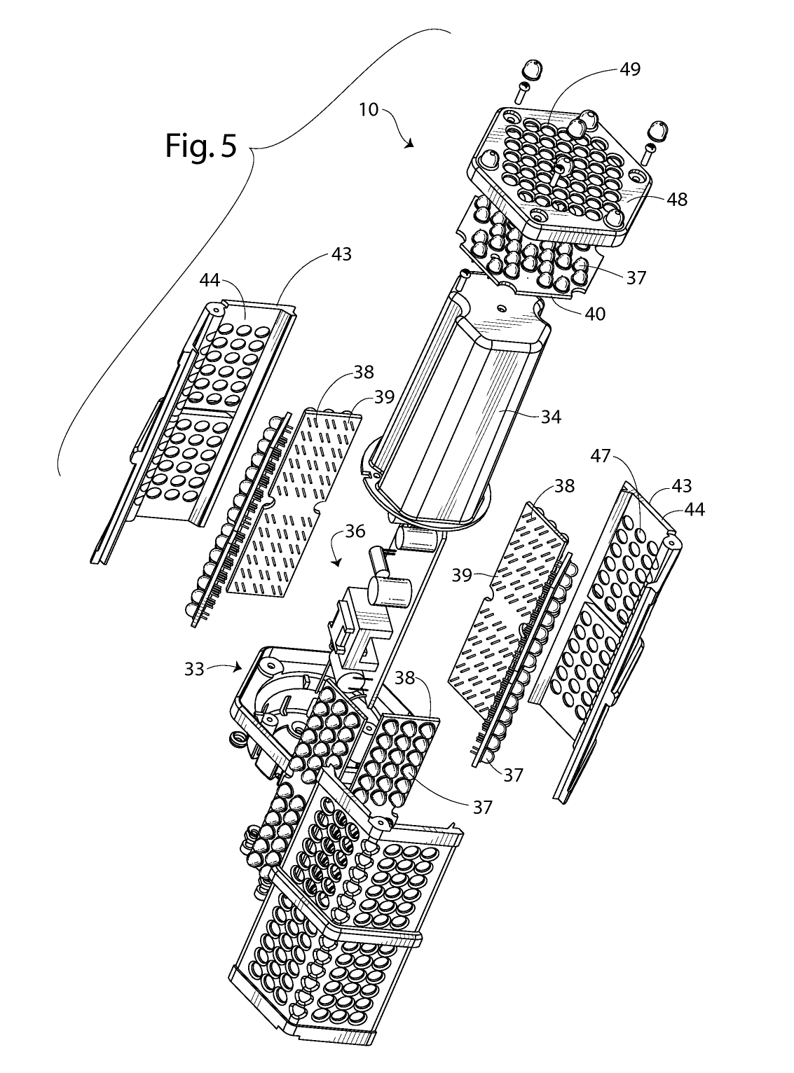

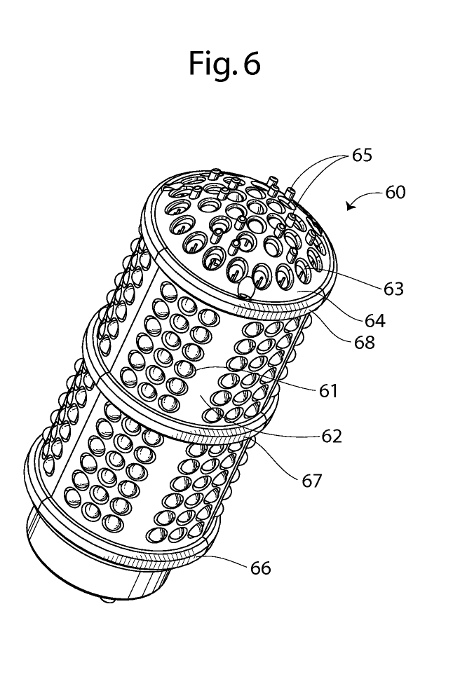

With reference next to FIG. 6, there is shown a light 60 in another preferred form of the invention. Here, the light 60 is essentially the same as that shown in FIGS. 1-5 except that it has side wall(s) that are generally cylindrical in shape rather than hexagonal. Here the side wall panel(s) 61 and side wall protective plate(s) 62 are cylindrical in shape. Also, the end panel 63 and end plate 64 is dome shaped. Furthermore, the end plate 64 has a plurality of grouped projections 65 extending longitudinally which protect the LED lights should the end of the light 60 come in contact with an object. Again, the light 60 has an annular rear ridge 66, middle ridge 67, and front ridge 68 which are raised from the surface of the underlying side plates 62 to protect the LED lights from unwanted contact.

It thus is seen that a combination light and light fixture is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. A light for replacing a conventional fluorescent light bulb comprising,
a mounting housing having a tubular side wall and an end wall coupled to one end of said tubular side wall;
a plurality of LED lights coupled to said mounting housing side wall;
a plurality of LED lights coupled to said mounting housing end wall, and
a fluorescent light fixture receptacle connector coupled to said mounting housing opposite said end wall and electrically coupled to said LED lights.

2. The light of claim 1 further comprising at least two annular protective ridges extending circumferentially about and outwardly from said mounting housing tubular side wall.

3. The light of claim 2 further comprising a plurality of protective elements extending outwardly from said end wall.

4. The light of claim 1 wherein said mounting housing tubular side wall is a hexagonal tube.

5. The light of claim 1 wherein said mounting housing tubular side wall is cylindrical tube.

6. The light of claim 5 wherein said end wall is generally a dome.

7. The light of claim 1 further comprising a tubular protecting plate positioned concentrically about said mounting housing tubular side wall.

8. The light of claim 1 wherein said LED lights are arranged in an elongated annular array.

9. A light for replacing a conventional fluorescent light bulb comprising,
a mounting housing having a tubular side wall;
a plurality of annular arrays of LED lights, said plurality of annular arrays of LED lights being aligned longitudinally along said tubular side wall, and
a fluorescent light fixture receptacle connector coupled to said mounting housing opposite said end wall and electrically coupled to said LED lights.

10. The light of claim 99 further comprising a mounting housing end wall coupled to said tubular side wall.

11. The light of claim 10 further comprising a plurality of LED lights coupled to said end wall and electrically coupled to said receptacle connector.

12. The light of claim 9 further comprising at least two annular protective ridges extending circumferentially about and outwardly from said mounting housing tubular side wall.

13. The light of claim 11 further comprising a plurality of protective elements extending outwardly from said end wall.

14. The light of claim 9 wherein said mounting housing tubular side wall is a hexagonal tube.

15. The light of claim 9 wherein said mounting housing tubular side wall is cylindrical tube.

16. The light of claim 15 wherein said end wall is generally a dome.

17. The light of claim 9 further comprising a tubular protecting plate positioned concentrically about said mounting housing tubular side wall.

18. A light for replacing a conventional fluorescent light bulb comprising,
a tubular mounting housing;
a plurality of LED lights coupled to said tubular mounting housing so as to direct light outwardly from said tubular mounting housing in a pattern generally 360 degrees about said tubular mounting housing;
and a fluorescent light fixture receptacle connector coupled to said mounting housing opposite said end wall and electrically coupled to said LED lights.

19. The light of claim 18 further comprising at least two annular protective ridges extending circumferentially about and outwardly from said mounting housing tubular side wall.

20. The light of claim 18 wherein said tubular mounting housing includes an end wall and wherein said light further comprises a plurality of LED lights coupled to said tubular mounting housing end wall.
